(19) United States
(12) Patent Application Publication
(10) Pub. No.: US 2019/0241186 A1
(43) Pub. Date: Aug. 8, 2019

(54) MULTI-PURPOSE HIGH-AGILITY TYPE AUTOMATIC CONVERSION HYBRID POWER MOTORCYCLE FOR PROVIDING PLUG-IN METHOD

(71) Applicant: MEDIA TECH CO., LTD., Seoul (KR)

(72) Inventor: Sang Joon LEE, Chungju-si, Chungcheongbuk-do (KR)

(73) Assignee: MEDIA TECH CO., LTD., Seoul (KR)

(21) Appl. No.: 16/333,412

(22) PCT Filed: Nov. 22, 2016
(86) PCT No.: PCT/KR2016/013443

§ 371 Date: Mar. 14, 2019

(30) Foreign Application Priority Data
Sep. 29, 2016 (KR) 10-2016-0125435

(51) Int. Cl. B60W 30/182; B60K 6/40; B60K 6/383; B60K 7/00; B60K 6/26; B60W 20/00; B60W 50/00

(52) U.S. Cl. CPC B60W 30/182; B60K 6/40; B60K 6/383; B60K 7/0007; B60K 6/26; B60Y 2200/12; B60W 50/00; B60W 2050/0026; B60W 2300/36; B60Y 2200/92; B60Y 2400/60; B60W 20/00

(57) ABSTRACT

A motorcycle which provides multi-purpose high-agility hybrid power having an integrated rear-wheel structure in which a tire is mounted on an outer wheel is disclosed. An electric motor and a one-way clutch are mounted on an inner wheel. The motorcycle provides a plug-in mode and provides automatic power conversion to reduce the overload of the electric motor in an automatic driving mode.

### TECHNICAL FIELD

The present invention relates to a motorcycle and more particularly, to a motorcycle with an integrated rear-wheel structure for providing multi-purpose high-agility type hybrid power, providing a plug-in method, and providing automatic power conversion.

### BACKGROUND ART

Motorcycles have been used as a variety of tools such as small-scale cargo conveying means, commuting transportation means, and leisure means in the city center. In conventional motorcycles, an internal combustion engine is used as a power source, and a two-cycle gasoline engine is mainly used as the internal combustion engine.

However, the two-cycle gasoline engine has a large output and torque so that the motorcycle can easily climb the steep hill, but has a problem that exhaust gas generated from the combusted gasoline is discharged, and a large noise is generated in the engine at the time of acceleration.

In recent years, to solve the problems of the related art, a hybrid motorcycle using an electric motor in the internal combustion engine has been developed and a driving means for automatically switching between the electric motor and the internal combustion engine is being developed.

Korean Patent Registration No. 1219059 relates to a hybrid motor scooter with high power efficiency, which a rear wheel drive by the electric motor and a rear wheel drive by the internal combustion engine may be selectively performed and an air gap between magnets attached to a magnet frame of the electric motor may be kept constant for all directions by aligning an electric stator shaft and a final shaft in a straight line.

However, in Korean Patent Registration No. 1219059, there is a problem in that the magnet frame is assembled to the other side of the rear wheel in the form of a bolt so that the bolt may be released by impact, and since a one-way clutch is disposed inside the transmission of the engine, a separate operation for disassembling the interior of the transmission is required to replace the one-way clutch.

Korean Utility Model Publication No. 2014-0004801 relates to a hybrid motorcycle and discloses a technique for driving an engine and an electric motor by an operation of a manual mode, an automatic mode, and a combined mode, but there is a problem in that the load state of the electric motor is not accurately detected based only on a preset speed.

Korean Patent Publication No. 2015-0022142 relates to a hybrid motorcycle having an automatic power conversion apparatus and discloses a technique for automatically switching between the operation of an electric motor and an engine in accordance with the load state of the electric motor. However, there is a problem in that the load state of the electric motor is not accurately detected by varying the maximum output of the electric motor compared with the remaining capacity of the battery.

### DISCLOSURE

### Technical Problem

The present invention provides a motorcycle for providing multi-purpose hybrid power with an integrated rear-wheel structure for accommodating an electric motor and a one-way clutch.

The present invention provides a motorcycle for providing multi-purpose hybrid power with aligning means for aligning a rear wheel and a front wheel which are formed at preset intervals between a first spline shaft and a second spline shaft in a final shaft.

The present invention provides a motorcycle for providing high-agility automatic power conversion which controls an operating part by comparing a correction value converted by applying sensor information to a speed weighting table with a speed threshold value in real time.

### Technical Solution

According to an embodiment of the present invention, there is disclosed a motorcycle for providing multi-purpose hybrid power using an electric motor and an engine including: a rear wheel which has a space accommodating the electric motor and rotates by a magnetic frame of the electric motor; a final shaft which receives a driving force of the engine to transmit the driving force to a one-way clutch; and a first wheel cap which has a hole passing through a part of the final shaft and in which a space accommodating the one-way clutch is formed and is coupled to one side of a rear wheel to transmit a driving force of the one-way clutch to the rear wheel, in which a tire is mounted on an outer wheel and the electric motor and the one-way clutch are mounted on an inner wheel to have an integrated rear wheel structure.

The final shaft may include a first spline shaft which is coupled to a final gear of a transmission to receive the driving force of the engine; a second spline shaft which is coupled to the one-way clutch to transmit the driving force of the engine to the one-way clutch; and an alignment means which is formed between the first spline shaft and the second spline shaft at a predetermined interval to align the rear wheel and a front wheel.

The final shaft may further include a snap groove which has a groove at a predetermined portion of the first spline shaft and is coupled with a snap ring to prevent the deviation between the final gear and the first spline shaft; and a thread which is formed at a front end of the second spline shaft and coupled with a bolt to prevent the deviation of the one-way clutch.

The motorcycle for providing multi-purpose hybrid power may further include a fixing shaft which operates as a central shaft of the electric motor and has a hollow cup-shaped shafting portion at one side; a first support means which is formed inside the shafting portion and coupled with the other side of the final shaft to support the final shaft running idle; a second support means which is coupled with the other side of the fixing shaft to support the fixing shaft; and a second wheel cap which has a hole passing through a part of the fixing shaft and a space embedding the second support means and is coupled with the other side of the rear wheel to prevent the deviation of the electric motor.

According to another embodiment of the present invention, there is closed a motorcycle for providing automatic power conversion using an electric motor and an engine including: a storage part which stores a speed weight table provided corresponding to the amount of charge remaining, the angle, and the weight of the battery and reference information including a speed threshold value and a battery remaining threshold value for automatic switching; an operating part which operates the electric motor or the engine; a sensor part which includes at least one of an inclination angle sensor sensing the angel of an slope, a weight sensor sensing the weight applied to the motorcycle, a speed sensor sensing a moving speed, and a battery sensor sensing the capacity of the battery supplying current to the electric motor; a mode selection part which receives one of a motor driving mode driven by the electric motor, an engine driving mode driven by the engine, and an automatic driving mode automatically switching between the driving of the electric motor and the engine; and a control part which controls the operating part by comparing sensor information of the sensor part with reference information when receiving the automatic driving mode, in which the overload of the electric motor is reduced in the automatic driving mode.

The control part may control the operating part by comparing a correction value converted by applying sensor information to the speed weight table with a speed threshold value, and if the battery capacity is less than the battery remaining threshold value, the mode may be automatically switched to an engine driving mode.

The mode selection part may receive one of a sports mode driven by an RPM of a predetermined high level and a safe mode driven by switching an RPM of a predetermined low level step by step.

The automatic driving mode may be a mode which is automatically switched from the electric motor to the engine or automatically switched from the engine to the electric motor to be driven.

### Advantageous Effects

According to the present invention, it is possible to efficiently reduce the number of components and reduce the time required for maintenance by molding an integrated rear-wheel structure accommodating an electric motor and a one-way clutch.

Further, it is possible to increase the stability of the motorcycle for providing the multi-purpose high-agility hybrid power and enhance the feeling of driving of the user by providing an alignment means aligning a rear wheel and a front wheel.

Further, it is possible to efficiently reduce the overload of the electric motor in an automatic driving mode by comparing sensor information and reference information and efficiently decrease the error of an element that determines the overload of the electric motor in response to the speed or the inflow current of the electric motor.

### DESCRIPTION OF DRAWINGS

FIG. 1 is a cross-sectional view showing a rear wheel of a motorcycle for providing multi-purpose high-agility hybrid power of the present invention.

FIG. 2 is an exploded perspective view showing the rear wheel of the motorcycle for providing multi-purpose high-agility hybrid power of the present invention.

FIG. 3 shows a final shaft of the present invention.

FIG. 4 is a cross-sectional view showing a first wheel cap of the present invention.

FIG. 5 is a block diagram showing a motorcycle for providing automatic power conversion of the present invention.

### MODES OF THE INVENTION

Hereinafter, embodiments of the present invention will be described in detail with reference to the accompanying drawings and the contents disclosed in the accompanying drawings, but the present invention is not limited or restricted to the embodiments.

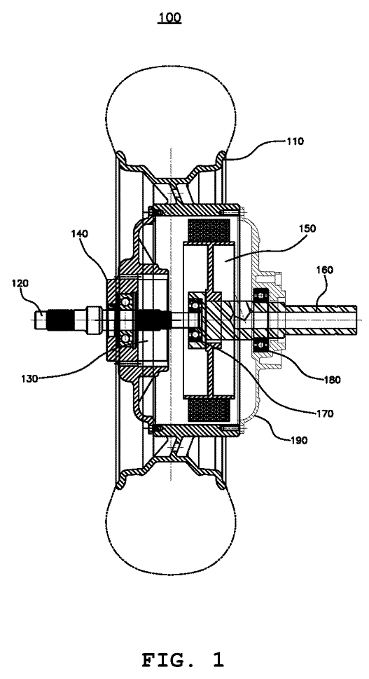

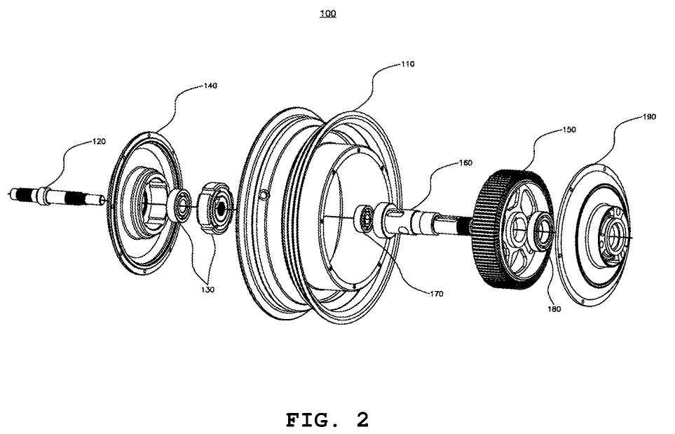

FIG. 1 is a cross-sectional view showing a rear wheel of a motorcycle for providing multi-purpose high-agility hybrid power of the present invention and FIG. 2 is an exploded perspective view showing the rear wheel of the motorcycle for providing multi-purpose high-agility hybrid power of the present invention.

The motorcycle for providing multi-purpose high-agility hybrid power of the present invention is driven by a rear wheel 100 and provides rear-wheel driving by an electric motor 150 and rear-wheel driving by an engine and provides a plug-in method.

The motorcycle of the present invention is characterized by providing multi-purpose high-agility hybrid power such as small-scale cargo conveying means, commuting transportation means, and leisure means.

The motorcycle may be a motor scooter, and the electric motor 150 may be a BLDC motor as an electric motor, and the engine may be a two-cycle gasoline engine, but the present invention is not limited thereto. The electric motor 150 includes a fixing shaft 160 operating as a central side, a rotator as a permanent magnet, a stator formed of a coil, and a magnetic frame.

The rear wheel 100 of the motorcycle for providing the multi-purpose high-agility hybrid power of the present invention includes a rear wheel 110, a final shaft 120, a one-way clutch 130, a first wheel cap 140, an electric motor 150, a fixing shaft 160, a first support means 170, a second support means 180, and a second wheel cap 190.

The rear wheel 110 is formed with a space for accommodating the electric motor 150 and rotated by the magnetic frame of the electric motor 150. A transmission box in which transmission components are accommodated is formed outside the rear wheel 110.

In the related art, the rear wheel and the magnetic frame are assembled by a bolt, but in the present invention, a structure of the rear wheel 110 is improved to reduce the number of components efficiently, increase the stability of the electric motor, and facilitate maintenance.

The rear wheel 110 is divided into an outer tube portion that is in contact with a tire and an inner tube portion that accommodates the magnet frame of the electric motor 150, and the outer tube portion and the inner tube portion are formed as a mold to have an integral structure.

The finial shaft 120 receives the driving force of the engine and transmits the driving force to the one-way clutch 130. The one-way clutch 130 includes a bearing for preventing reverse rotation.

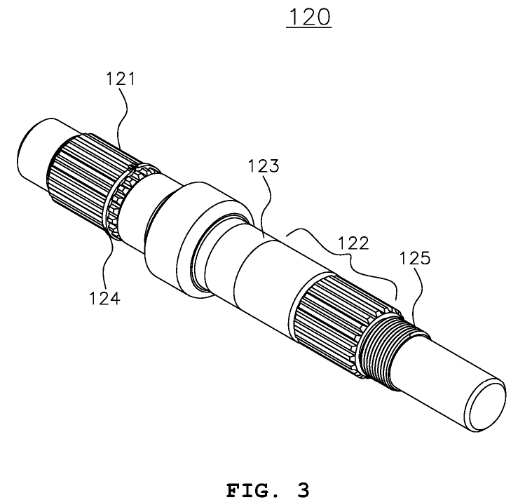

FIG. 3 shows the final shaft of the present invention, and the final shaft 120 includes a first spline shaft 121, a second spline shaft 122, and an alignment means 123.

The first spline shaft 121 is coupled with a negative gear (not shown) of the transmission to receive the driving force of the engine, the second spline shaft 122 is coupled with the one-way clutch 130 to transmit the driving force of the engine to the one-way clutch 130, and the alignment means 123 is formed at a preset interval between the first spline shaft 121 and the second spline shaft 122 to align the rear wheel 110 and the front wheel (not shown). For example, the alignment means 123 is a means for adjusting a center between the rear wheel 110 accommodating the electric motor 150 and the transmission box in which the transmission components are accommodated, and a means for adjusting a balance of the final shaft 120 in correspondence with the shaft length of the electric motor 150, resulting in a means for aligning the rear wheel 110 and the front wheel.

The present invention provides the alignment means 123 for aligning the rear wheel 110 and the front wheel to increase the balance of the motorcycle and enhance the feeling of driving of the user.

The finial 120 includes a snap groove 124 and a thread 125. The snap groove 124 is formed in a preset portion of the first spline shaft 121 and coupled with a snap ring to prevent the deviation between the final gear and the first spline shaft 121, and the thread 125 is formed at a front end of the second spline shaft 122 and coupled with the bolt to prevent the deviation of the one-way clutch 130.

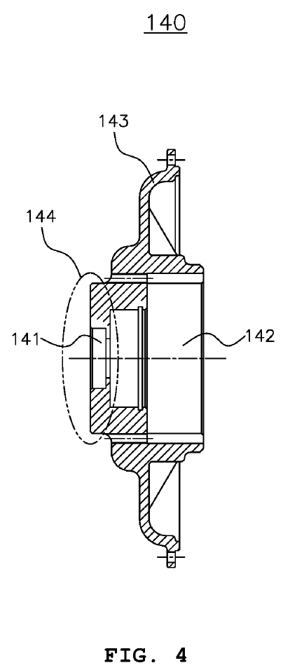

FIG. 4 is a cross-sectional view showing the first wheel cap of the present invention. The first wheel cap 140 has a shaft hole 141 passing through a part of the final shaft 120 and has a clutch accommodating groove 142 accommodating the one-way clutch 130, and the driving force of the one-way clutch 130 is transmitted to the rear wheel 110 through a clutch power transmission cap 143 coupled with one side of the rear wheel 110.

In the related art, the one-way clutch 130 is formed in the transmission box in which the transmission components are accommodated, but in the present invention, the one-way clutch 130 is formed in the space coupled with the first wheel cap 140 and one side of the rear wheel 110 to prevent the transmission box from being disassembled during maintenance.

The first wheel cap 140 further includes an auxiliary alignment means 144 formed at a predetermined insertion interval of the final shaft 120 in the shaft hole 141, and the auxiliary alignment means 144 is formed at the predetermined insertion interval to align the rear wheel 110 and the front wheel. For example, the user may adjust the insertion interval by polishing or cutting of the cross section of a part of the auxiliary alignment means 144 when the alignment of the rear wheel 110 and the front wheel is required.

In the present invention, the auxiliary alignment means 144 of the first wheel cap 140 may be provided in addition to the alignment means 123 of the final shaft 120 to increase the balance of the motorcycle and enhance the feeling of driving of the user.

The fixing shaft 160 operates as a central axis of the electric motor 150, and a hollow cup-shaped shafting portion is formed at one side.

The first support means 170 is formed inside the shafting portion and is coupled with the other side of the final shaft 120 to support the final shaft 120 running idle.

The second support means 180 is coupled with the other side of the fixing shaft 160 to support the fixing shaft 160. The first support means 170 and the second support means 180 include bearings for supporting and are aligned at the center of the one-way clutch 130, and the fixing shaft 160 and the final shaft 120 are aligned in a straight line so that an air gap between magnets attached to the magnetic frame of the electric motor 150 is kept constant for all directions.

The second wheel cap 190 is formed with a hole that penetrates a part of the fixing shaft 160 and a space for accommodating the second support means 180 and is coupled with the other side of the rear wheel 110 to prevent the deviation of the electric motor 150. The second wheel cap 190 is provided with a space for accommodating the second support means 180 so that a separate component such as a bolt for fixing the second support means 180 is unnecessary.

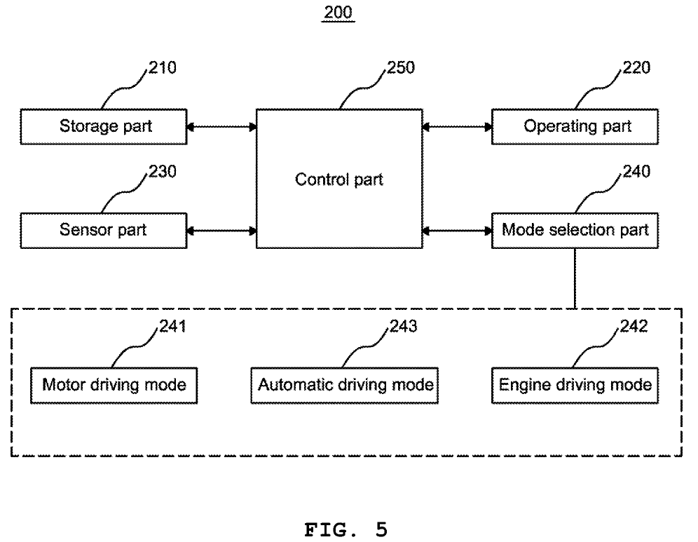

FIG. 5 is a block diagram showing a motorcycle for providing automatic power conversion of the present invention. The motorcycle 100 for providing the automatic power conversion is used as small-scale cargo conveying means and commuting transportation means by providing the automatic power conversion using the electric motor and the engine, and is used as a multi-purpose means such as a safe means for novice or experienced drivers and a leisure means by providing a safe mode and a sport mode.

The motorcycle 100 for providing the automatic power conversion includes a storage part 210, an operating part 220, a sensor part 230, a mode selection part 240, and a control part 250.

The storage part 210 stores reference information including conditions for mutually operating the electric motor and the engine and the operating part 220 includes a means for operating the electric motor and the engine.

The maximum output of the electric motor varies depending on the amount of charge remaining of a battery, and the load varies in accordance with the angle of the slope such as an uphill or downhill road. Further, the load of the electric motor varies depending on the weight of the occupant, the passenger or the object.

The storage part 210 stores a speed weight table provided corresponding to the amount of charge remaining, the angle, and the weight of the battery and reference information including a speed threshold value and a battery remaining threshold value for automatic switching.

The speed weight table includes a speed value converted in response to each of three factors, such as the amount of charge remaining, the angle, and the weight of the battery, and may include a weighted speed value to which the three factors are applied.

The sensor part 230 includes at least one of an inclination angle sensor, a weight sensor, a speed sensor, and a battery sensor.

The inclination angle sensor is a sensor for detecting the angle of the slope, and the weight sensor is a sensor for sensing the weight applied to the motorcycle. For example, the weight sensor senses the weight of an occupant, a passenger, or an object. The speed sensor is a sensor that senses the moving speed during driving, and the battery sensor is a sensor that senses the capacity of the battery that supplies current to the electric motor.

The mode selection part 240 includes a motor driving mode 241 driving by the electric motor, an engine driving mode 242 for driving by an engine, and an automatic driving mode 243 for automatically switching between the electric motor and the engine.

The automatic driving mode 243 may be a driving mode which is automatically switched from the electric motor to the engine or automatically switched from the engine to the electric motor. The automatic driving mode 243 may provide a driving mode which is automatically switched from the electric motor to the engine or automatically switched from the engine to the electric motor when starting up.

The control part 250 controls the operating part 220 by comparing sensor information of the sensor part 230 with the reference information when the automatic driving mode 243 is received, thereby reducing the overload of the electric motor in the automatic driving mode 243.

The control part 250 controls the operating part by comparing a correction value converted by applying sensor information to the speed weight table with a speed threshold value, and if the battery capacity is less than the battery remaining threshold value, the mode is automatically switched to an engine driving mode.

The mode selection part 240 provides a means for selecting a driving mode according to the driver's tendency and skill. The mode selection part 240 receives one of a sports mode that is driven at an RPM of a preset high level and a safe mode that is driven by changing an RPM of a preset low level step by step.

The safe mode is a starting mode for a beginner or an initial operator, which is a mode that divides the maximum RPM into several levels and is converted and driven stepwise to each level by interlocking with an accelerator.

The sports mode is a starting mode for experienced drivers or speed-conscious drivers, which is a mode driven at rapid start or rapid acceleration with the maximum RPM.

The control part 250 controls the safe mode to operate at a preset low RPM to be driven by the electric motor and controls the sports mode to operate at a preset high RPM to be driven by the engine, and may control the driving of the electric motor and the engine to be automatically switched in response to the sensor information.

A motorcycle 200 for providing automatic power conversion of the present invention further includes a display means (not shown) including at least one of a speaker, an LED, and a display for displaying the mode selection part 240.

The display means may display an operation of the sensor part 230 or a processing operation of the control part as well as an operation of the mode selection part 240 and display a charging status when the battery is charged by plug-in.

The display means may generate an engine sound while traveling by the electric motor to alarm the surrounding pedestrians. For example, since the output sound of the electric motor is very quiet, the display means can artificially generate a simulated engine sound to alarm the pedestrians for safety.

### INDUSTRIAL AVAILABILITY

The present invention may be used as a motorcycle for providing high-agility hybrid power having an integrated rear-wheel structure, a motorcycle for providing a plug-in method, or a motorcycle for providing automatic power conversion.

What is claimed is:

1. A motorcycle for providing multi-purpose hybrid power using an electric motor and an engine comprising:
a rear wheel which is formed with a space accommodating the electric motor and rotated by a magnetic frame of the electric motor;
a final shaft which receives a driving force of the engine and transmits the driving force to a one-way clutch; and
a first wheel cap which has a hole passing through a part of the final shaft and in which a space for accommodating a one-way clutch is formed and is coupled to one side of a rear wheel to transmit a driving force of the one-way clutch to the rear wheel,
wherein a tire is mounted on an outer wheel and the electric motor and the one-way clutch are mounted on an inner wheel to have an integrated rear wheel structure.

2. The motorcycle for providing multi-purpose hybrid power of claim 1, wherein the final shaft includes
a first spline shaft which is coupled to a final gear of a transmission to receive the driving force of the engine;
a second spline shaft which is coupled to the one-way clutch to transmit the driving force of the engine to the one-way clutch; and
an alignment means which is formed between the first spline shaft and the second spline shaft at a predetermined interval to align the rear wheel and a front wheel.

3. The motorcycle for providing multi-purpose hybrid power of claim 2, wherein the final shaft further includes
a snap groove which has a groove at a predetermined portion of the first spline shaft and is coupled with a snap ring to prevent the deviation between the final gear and the first spline shaft; and
a thread which is formed at a front end of the second spline shaft and coupled with a bolt to prevent the deviation of the one-way clutch.

4. The motorcycle for providing multi-purpose hybrid power of claim 1, further comprising:
a fixing shaft which operates as a central shaft of the electric motor and has a hollow cup-shaped shafting portion at one side;
a first support means which is formed inside the shafting portion and coupled-with the other side of the final shaft to support the final shaft-running idle;
a second support means which is coupled with the other side of the fixing shaft to support the fixing shaft; and
a second wheel cap which has a hole passing through a part of the fixing shaft and a space embedding the second support means and is coupled with the other side of the rear wheel to prevent the deviation of the electric motor.

5. A motorcycle for providing automatic power conversion using an electric motor and an engine comprising:
a storage part which stores a speed weight table provided corresponding to an amount of charge remaining, an angle, and a weight of a battery and reference information including a speed threshold value and a battery remaining threshold value for automatic switching;
an driving part which operates the electric motor or the engine;
a sensor part which includes at least one of an inclination angle sensor sensing the angel of an slope, a weight sensor sensing the weight applied to the motorcycle, a speed sensor sensing a moving speed, and a battery sensor sensing the capacity of the battery supplying current to the electric motor;
a mode selection part which receives one of a motor driving mode driven by the electric motor, an engine driving mode driven by the engine, and an automatic driving mode automatically switching between the electric motor and the engine; and
a control part which controls the driving part by comparing sensor information of the sensor part with reference information when receiving the automatic driving mode,
wherein the overload of the electric motor is reduced in the automatic driving mode.

6. The motorcycle for providing automatic power conversion of claim 5, wherein the control part controls the driving part by comparing a correction value converted by applying sensor information to the speed weight table with a speed threshold value, and if the battery capacity is less than the battery remaining threshold value, the mode is automatically switched to an engine driving mode.

7. The motorcycle for providing automatic power conversion of claim 5, wherein the mode selection part receives one of a sports mode driven by an RPM of a predetermined high level and a safe mode driven by changing an RPM of a predetermined low level step by step.

8. The motorcycle for providing automatic power conversion of claim 5, wherein the automatic driving mode is a mode which is automatically switched from the electric motor to the engine or automatically switched from the engine to the electric motor.
